(19) United States
(12) Patent Application Publication
(10) Pub. No.: US 2002/0117257 A1
(43) Pub. Date: Aug. 29, 2002

(54) Application solution comprising sodium chloride and a method of applying a pressure sensitive adhesive coated film to a substrate

(75) Inventor: Verna M. Kubik, Houlton, WI (US)

Correspondence Address: Attention: Scott R. Pribnow, Office of Intellectual Property Counsel, 3M Innovative Properties Company, P.O. Box 33427, St. Paul, MN, 55133-3427, US

(73) Assignee: 3M Innovative Properties Company

(21) Appl. No.: 09/741,373

(22) Filed: Dec. 18, 2000

(51) Int. Cl. C09J 5/00

(52) U.S. Cl. 156/305; 156/327; 156/332

(57) ABSTRACT

An application solution for use in bonding a pressure sensitive adhesive-coated film on a surface is reported. The application solution comprises water, a wetting agent, and sodium chloride. The application solution reduces or eliminates adhesive blushing that may occur when pressure sensitive adhesives come into contact with water or water-based application solutions. Also disclosed is a concentrate for preparing an application solution and an improved method of applying a pressure sensitive adhesive-coated film to a substrate.

### BACKGROUND

It is well known to adhesively bond pressure sensitive adhesive (PSA) coated polymer films onto substrates such as windows in order to provide the substrates with an improved property, for example, vandalism/graffiti resistance, shatter resistance, glare control and/or energy control. Examples of multi-layered vandalism/graffiti resistant films are reported in U.S. Ser. No. 09/181,532 (Janssen et al.). Multi-layered vandalism/graffiti resistant films are commercially available under the trade designation “3M WINDOW PROTECTION SHIELD(S)” from Minnesota Mining and Manufacturing Company (St. Paul, Minn.). Examples of pressure sensitive adhesive coated polymer films for shatter resistance, glare control and/or energy control are reported in U.S. Pat. No. 4,288,493 (Kropp), Re 29,663 (Theissen), U.S. Pat. No. 4,226,910 (Dahlen et al.), and U.S. Pat. No. 4,028,475 (Willdorf). Pressure sensitive adhesive coated window films suitable for shatter resistance and/or energy control are commercially available under the trade designations “SCOTCHTINT” and “SCOTCHSHIELD” from Minnesota Mining and Manufacturing Company (St. Paul, Minn.).

One commonly used method of applying the PSA-coated polymer films is best described as a “wet” application technique. In a wet application, the pressure sensitive adhesive layer of the film and/or the substrate is first wet with an application solution. The application solution is typically sprayed onto the surface of the substrate and pressure sensitive adhesive in a fine mist so that relatively uniform coverage of the pressure sensitive adhesive and/or substrate is obtained. The pressure sensitive adhesive layer is then brought into contact with the surface of the substrate such that a layer of application solution is present at the interface between the pressure sensitive adhesive and the substrate. The layer of application solution interrupts the adhesive bonding of the pressure sensitive adhesive layer to the substrate thereby allowing the PSA-coated film to be precisely positioned on the substrate. After the film has been positioned, the bulk of the application solution is then removed from between the pressure sensitive adhesive and the substrate by applying pressure to the polymer film, for example, using a squeegee which forces the application solution to an outer edge of the film. Once the application solution is removed, an adhesive bond is formed between the pressure sensitive adhesive and the substrate. The strength of the adhesive bond may increase over time as the remaining application solution evaporates.

Application solutions heretofore used in a wet application technique typically comprise a dilute (i.e., about 0.01% to about 1%-wt.) water-based solution of a wetting agent or surfactant, very commonly a household detergent or soap such as those commercially available under the trade designations “JOY” (from Procter & Gamble Corp., Cincinnati Ohio) and “ELECTRASOL” (from Reckitt Benckiser Corp., Danbury, Conn.). The wetting agent functions to reduce the surface tension of the water thereby allowing the application solution to wet-out the surface of the substrate in a relatively continuous coating.

It has been observed that when application solutions are used to apply pressure sensitive adhesive-coated films to substrates a phenomenon described as “blushing” may occur. Blushing is used to describe the appearance of cloudiness or haziness in the pressure sensitive adhesive when it is in contact with water or an application solution comprising a wetting agent. Blushing leads to an unacceptable film installation since the cloudiness or haziness interferes with the optical clarity of the film. It is believed that blushing occurs due to an interaction between the pressure sensitive adhesive and the application solution. The appearance of blushing may disappear or diminish when the application solution used to apply the film dries out. However, this is unacceptable for many types of pressure sensitive adhesive coated films, especially those that due to their thickness and/or construction allow the passage of water at a slow rate, for example, thick or multi-layered pressure sensitive adhesive coated films. In view of the foregoing, an improved application solution that reduces or eliminates the occurrence of blushing in the application of pressure sensitive adhesive coated films to substrates is highly desirable.

### SUMMARY

The present invention provides an improved application solution for use in applying a pressure sensitive adhesive-coated film to a surface, the application solution comprising water, a wetting agent, and sodium chloride. Application solutions of the present invention have been found to reduce or eliminate the occurrence of adhesive blushing when used to apply pressure sensitive adhesive coated films to substrates.

The improved application solution of the present invention has been found to reduce or eliminate the occurrence of adhesive blushing, especially when the pressure sensitive-adhesive coated film comprises an acrylic adhesive. In a preferred embodiment of the application solution the wetting agent is present in an amount ranging from about 0.01% to about 5% by weight of the application solution, more preferably ranging from about 0.025% to about 1.0% by weight. In a preferred embodiment the wetting agent is a detergent, for example, a nonionic, ionic, or cationic detergent.

Application solutions of the present invention comprise sodium chloride. In a preferred embodiment of the application solution sodium chloride is present in an amount of about 0.1 g/ml or greater, more preferably about 0.25 g/ml or greater, and most preferably about 0.5 g/ml. In a preferred embodiment, the sodium chloride is present in the application solution in an amount ranging from about 0.1 g/ml to about 2 g/ml, more preferably ranging from about 0.25 g/ml to about 0.5 g/ml.

The present invention also provides an application solution concentrate that may be diluted with water to form an application solution, the application solution concentrate comprising water, a wetting agent, and about 0.2 g/mil to about 40 g/ml sodium chloride. The application solution concentrate can be diluted in a predetermined dilution ratio, for example, 1:1, 2:1, 5: 1, 10:1 to provide an application solution of the present invention.

The present invention also provides a method for applying a pressure sensitive adhesive-coated film to a substrate having a surface, the method comprising the steps of:

(a) wetting at least one of the surface of the substrate and the pressure sensitive adhesive with an application solution of the present invention comprising water, a wetting agent, and sodium chloride;

(b) placing the pressure sensitive adhesive of the film onto the surface of the substrate such that the application solution is present between the pressure sensitive adhesive and the surface of the substrate; and

(c) removing at least a portion of the application solution from between the pressure sensitive adhesive and the surface resulting in adhesive bonding between the pressure sensitive adhesive and the substrate.

In a preferred embodiment of the method of the present invention the substrate is a window of a train, bus or automobile and comprises glass, polycarbonate or acrylic.

In a preferred embodiment the film comprises polyester, polycarbonate, or acrylic, mixtures thereof or laminates thereof.

In a preferred embodiment the pressure sensitive adhesive comprises an acrylic pressure sensitive adhesive.

### DETAILED DESCRIPTION

The present invention provides an improved application solution for use in applying a pressure-sensitive adhesive coated sheet to a substrate. The application solution comprises water, a wetting agent, and sodium chloride.

Application solutions of the present invention comprise a wetting agent. As used herein the term “wetting agent” is used to refer to materials that, when added to water, reduce the surface tension of the water allowing it to more easily spread over the surface of another material. Examples of wetting agents include surfactants, detergents, and soaps. The wetting agent functions to reduce the surface tension of the application solution so that it wets out the surface of the substrate to which the film is to be applied. One preferred type of wetting agent is a detergent, most preferably a low bubble or foam generating detergent such as a dishwashing detergent. Detergents include, for example, sodium soaps of fatty acids, and synthetic detergents such nonionic, cationic, and anionic compounds. Representative examples of synthetic detergents include linear alkyl sulfonates (LAS) and alkyl benzene sulfonates (ABS). The wetting agent is present in the application solution of the present invention in an amount sufficient to reduce the surface energy of the water to an acceptable level to allow the application solution to wet-out the surface of the substrate. Generally speaking, it is desirable to limit the total amount of wetting agent in the application solution in order to minimize foaming and/or bubbling of the application solution and in order to minimize interference between the pressure sensitive adhesive and the substrate. Preferably, the wetting agent is present in the application solution in an amount ranging from about 0.01% to about 5% by weight of the application solution, more preferably ranging from about 0.025% to about 1.0% by weight. The amount of wetting agent required will vary, for example, depending upon the type of wetting agent employed and the presence of fillers or abrasive particles in the wetting agent. One preferred wetting agent is the dishwasher detergent commercially available under the trade designation “ELECTRASOL” from Reckitt Benckiser Corp., (Danbury, Conn.). A preferred application solution comprises about 0.01% by weight of ELECTRASOL. Another preferred wetting agent is commercially available under the trade designation “AO-455” from Tomah Products (Milton, Wis.). A suitable wetting agent is the dishwashing liquid commercially available under the trade designation “JOY” from Proctor & Gamble (Cincinnati Ohio).

Application solutions of the present invention further comprise sodium chloride (i.e., NaCl). When added to an application solution of the prior art, sodium chloride has been found to reduce or eliminate the occurrence of adhesive blushing, especially when the pressure sensitive adhesive on the film is an acrylic pressure sensitive adhesive. It is believed that application solutions of the prior art interact with the pressure sensitive adhesive causing a change in the index of refraction of the pressure sensitive adhesive. The change in index of refraction results in the appearance of cloudiness or haziness, commonly known as blushing in the pressure sensitive adhesive. Application solutions of the present invention comprising sodium chloride have been found to greatly reduce or eliminate the occurrence of blushing. Although not wishing to be bound by any theory, it is believed that the presence of sodium chloride in the application solution modifies the ionic strength of the application solution leading to a reduction in the interaction between the application solution and the pressure sensitive adhesive. Application solutions of the present invention comprise sodium chloride in an amount of about 0.1 g/ml or greater, more preferably in an amount of about 0.25 g/ml or greater, and most preferably in an amount of about 0.5 g/ml or greater. In a preferred embodiment, the application solution comprises sodium chloride in an amount ranging from about 0.1 g/ml to about 2 g/ml, more preferably ranging from about 0.25 g/ml to about 0.5 g/ml. It should be noted that since sodium chloride is a strong electrolyte, it exists in a completely dissociated state (i.e., Na⁺ and Cl⁻ ions) in the application solution of the present invention. Therefore, the amounts of sodium chloride referred to herein are calculated prior to dissociation of the sodium chloride into Na⁺ and Cl⁻ ions.

Application solutions of the present invention may be prepared by mixing the components in any order. Typically, it will be desirable to add the wetting agent and the sodium chloride to the water, followed by mixing to form a homogeneous solution. Optionally, the application solution may be filtered to remove impurities.

When used in accordance with the method of the present invention, the application solution is applied to: (1) the surface of the pressure sensitive adhesive, or (2) the surface of the substrate to which the pressure-sensitive adhesive coated film is to be applied, or (3) both. Typically, the application solution is applied using a pressurized or pump-style spray bottle that applies the application solution in the form of a fine spray or mist. Next, the pressure sensitive adhesive is brought into contact with the surface of the substrate such that a layer of application solution is present between the pressure sensitive adhesive and the surface of the substrate. The next step is to apply pressure to at least a portion of the surface of the film to cause the pressure sensitive adhesive to bond to the surface of the substrate. Pressure may be applied, for example, using a plastic squeegee or a roller. Squeegeeing pressure is typically applied working from the center of the film outward toward an edge. In this way, the squeegeeing pressure forces the application fluid to an edge of the film where it can be absorbed, for example, with an absorbent cloth or towel.

The substrate may be any desired substrate. Typically, the substrate comprises a transparent material such as glass, acrylic, or polycarbonate. Most typically, the substrate is the transparent portion of a window, for example, a bus window, train window, automobile window, or architectural glazing.

The film typically comprises one or more layers of a polymeric material such as polyester (i.e., PET), polyolefin, polycarbonate, acrylic and the like. Optionally, the film may include deposited metal layers such as aluminum, silver, nickel and the like. The pressure sensitive adhesive is typically an acrylic pressure sensitive adhesive such as those reported in Satas, Donatas; Handbook of Pressure Sensitive Adhesive Technology; Chapter 15; Second Edition, 1989; Van Nostrand Reinhold Press and those reported in U.S. Pat. No. Re 24,906 (Ulrich).

In a preferred embodiment of the method of the present invention, the pressure sensitive adhesive coated film comprises a graffiti and vandalism resistant stack of sheets, wherein the topmost sheet can be removed from the stack of sheets by pulling it away from the stack such that the sheet being removed from the stack as well as the sheets remaining with the stack do not delaminate. Each sheet in the stack independently comprises: (a) a film, the film having a first side having a surface area and an opposite second side having a surface area; (b) a bonding layer (typically an acrylic pressure sensitive adhesive layer) having a first side having a surface area and an opposite second side having a surface area, wherein the bonding layer is bonded via its first side to the second side of the film such that at least a center of the surface area of the second side of the film is in contact with the bonding layer, wherein at least about 50 percent of the surface area of the second side of the film has the bonding layer bonded thereto; and (c) an optional release layer coated on the first side of the film. Graffiti and vandalism resistant films of this type are reported in U.S. Ser. No. 09/181,532 (Janssen et al.), filed Oct. 28, 1999, and are commercially available under the trade designation “3M WINDOW PROTECTION SHIELD(S)” from Minnesota Mining and Manufacturing Corporation (St. Paul, Minn.).

The following non-limiting examples will further illustrate the invention. All parts, percentages, ratios, etc. in the examples are by weight unless otherwise indicated.

### EXAMPLES

Preparation of Master Solution A:

To 99 grams of deionized water was added 1 gram of ELECTRASOL dishwashing detergent (available from Reckitt Benckiser Corp., Danbury Conn.). The ELECTRASOL dishwashing detergent was allowed to dissolve in the deionized water and was filtered with cheesecloth to form Master Solution A.

### Examples 1-9

Application solutions of the present invention were prepared by mixing the components listed below in the amounts listed below.

| | Example 1 | Example 2 | Example 3 | Example 4 |
|---|---|---|---|---|
| Deionized Water | 100 g | 100 g | 100 g | 100 g |
| Master Solution A | 1.0 g | 1.0 g | 1.0 g | 1.0 g |
| NaCl | 0.1 g | 0.25 g | 0.50 g | 0.75 g |
| | Example 5 | Example 6 | Example 7 | Example 8 |
| Deionized Water | 100 g | 100 g | 100 g | 100 g |
| Master Solution A | 1.0 g | 1.0 g | 1.0 g | 1.0 g |
| NaCl | 1.0 g | 2.5 g | 3.0 g | 5.0 g |

| | Example 9 |
|---|---|
| Deionized Water | 100 g |
| Master Solution A | 1.0 g |
| NaCl | 10.0 g |

### Comparative Examples A-C:

Comparative Example A was prepared by mixing the components listed below in the amounts listed below.

| | Comparative Example A |
|---|---|
| Deionized Water | 100 g |
| Master Solution A | 1.0 g |

Comparative Example B: distilled water

Comparative Example C: tap water

Test Procedure 1:

A PSA-lined pouch was prepared by first separating a 3 inch by 3 inch (7.5 cm by 7.5 cm) square piece of a 4 layer polyester film laminate (commercially available as “3M WINDOW PROTECTION SHIELD(S)” from Minnesota Mining and Manufacturing Corporation, St. Paul, Minn.) into two two-layer film samples and then adhering the PSA-coated surface of the two samples to each other along three edges of the square samples. The fourth edge was left unsealed to allow the reservoir of the pouch to be filled with application solution. Two polyester bead spacers were then placed into the reservoir of the pouch to prevent the pressure sensitive adhesive layers on opposite sides of the pouch from adhering to one another. An aliquot of 1.0 cm³ of application solution was poured into the reservoir of the pouch and the fourth side of the pouch was sealed to hold the application solution in the reservoir of the pouch in contact with the pressure sensitive adhesive layers. The pouch was allowed to age at room temperature for 72 hours. After aging, the pouch was visually inspected against a black background and the blushing of the pressure sensitive adhesive was rated using a linear scale ranging from 0 to 1, with 0 representing no visually observable blushing, and 1 representing severe blushing. The results are reported as “blushing” in Table 1.

TABLE 1

| Sample | Blushing |
|---|---|
| Example 1 | 0.5 |
| Example 2 | 0.1 |
| Example 3 | 0 |
| Example 4 | 0 |
| Example 5 | 0 |
| Example 6 | 0 |
| Example 7 | 0 |
| Example 8 | 0 |
| Example 9 | 0 |
| Comp Ex. A | 1.0 |
| Comp Ex.. B | 1.0 |
| Comp. Ex. C | 1.0 |

Patents, patent applications and publications disclosed herein are incorporated by reference as if individually incorporated. It is to be understood that the above description is intended to be illustrative and not restrictive. Various modifications and alterations of this invention will become apparent to those skilled in the art from the foregoing description without departing from the scope and the spirit of this invention, and it should be understood that this invention is not to be unduly limited to the illustrative embodiments set forth herein.

What is claimed is:

1. An application solution for use in applying a pressure sensitive adhesive-coated film to a surface, the application solution comprising:
(a) water;
(b) a wetting agent; and
(c) sodium chloride.

2. The application solution of claim 1 wherein the wetting agent is present in an amount ranging from about 0.01% to about 5.0% by weight of the application solution.

3. The application solution of claim 1 wherein the sodium chloride is present in an amount of about 0.1 g/ml or greater.

4. The application solution of claim 1 wherein the sodium chloride is present in an amount of about 0.25 g/ml or greater.

5. The application solution of claim 1 wherein the sodium chloride is present in an amount of about 0.5 g/ml or greater.

6. The application solution of claim 1 wherein the sodium chloride is present in an amount ranging from about 0. 1 g/ml to about 2 g/ml.

7. The application solution of claim 1 wherein the wetting agent is a detergent.

8. The application solution of claim 7 wherein the detergent is selected from the group consisting of nonionic, ionic, and cationic detergents.

9. The application solution of claim 7 wherein the detergent is selected from the group consisting of linear alkyl sulfonates and alkyl benzene sulfonates.

10. A method of applying a pressure sensitive adhesive-coated film to a substrate having a surface, the method comprising the steps of:
(a) wetting at least one of the surface of the substrate and the pressure sensitive adhesive with the application solution of claim 1;
(b) placing the pressure sensitive adhesive over the surface of the substrate such that the application solution is present between the pressure sensitive adhesive and the surface of the substrate; and
(c) removing at least a portion of the application solution from between the pressure sensitive adhesive and the surface of the substrate thereby causing the pressure sensitive adhesive to bond to the substrate.

11. The method of claim 10 wherein the pressure sensitive adhesive is an acrylic pressure sensitive adhesive.

12. The method of claim 10 wherein the film is selected from the group consisting of polyester, polyolefin, acrylic, polycarbonate, mixtures thereof, and laminates thereof.

13. The method of claim 10 wherein the substrate is selected from the group consisting of glass, acrylic, and polycarbonate.

14. The method of claim 10 further including the steps of:
(d) applying pressure to at least a portion of the film to force at least a portion of the application solution present between the pressure sensitive adhesive and the surface of the substrate to flow out from between the pressure sensitive adhesive and the substrate; and
(e) optionally, drying the application fluid that has been forced from between the pressure sensitive adhesive and the substrate.

15. An application solution for use in applying a pressure sensitive adhesive-coated film to a surface, the application solution consisting essentially of:
(a) water;
(b) about 0.01% to about 5.0% by weight of a wetting agent; and
(c) about 0.1 g/ml or greater sodium chloride.

16. An application solution concentrate that may be diluted with water to form an application solution, said application solution concentrate comprising:
(a) water;
(b) a wetting agent; and
(c) about 0.2 g/ml to 40 g/ml sodium chloride.
